(19) United States
(12) Patent Application Publication
(10) Pub. No.: US 2013/0238301 A1
(43) Pub. Date: Sep. 12, 2013

(54) Systems and Methods for Material Modeling and Prediction

(71) Applicants: Amit Kumar Kaushik, West Chester, OH (US); Richard William Hamm, Loveland, OH (US); Ronald Andrew Foerch, East Greenwich, RI (US)

(72) Inventors: Amit Kumar Kaushik, West Chester, OH (US); Richard William Hamm, Loveland, OH (US); Ronald Andrew Foerch, East Greenwich, RI (US)

(21) Appl. No.: 13/414,285

(22) Filed: Mar. 7, 2012

(51) Int. Cl. G06G 7/48

(52) U.S. Cl. 703/6

(57) ABSTRACT

Included are systems and methods for material modeling and prediction. Some systems and methods include determining test data for a test material. The test material may exhibit a plurality of interrelated material behaviors and the test data may relate to the plurality of interrelated material behaviors. Additionally, some systems and methods include providing the test data to a user, receiving a process from the user for decoupling at least two of the plurality of interrelated material behaviors, and, in response to receiving the process for decoupling at least two of the plurality of interrelated material behaviors, fitting a plurality of modules to simulate the test material.

### FIELD OF THE INVENTION

The present application relates generally to material modeling and prediction and specifically to modeling a plurality of material properties to predict material performance and capabilities.

### BACKGROUND OF THE INVENTION

In many manufacturing and processing processes, a material, such as a polymer, may be utilized in the process itself, as a product of the process, and/or both. As an example, in many manufacturing processes, a product may be constructed of a polymer. The final product may have a design that includes perforations and/or apertures that are created in the material during the manufacturing process. Accordingly, a process designer may desire the appropriate material for optimally creating the final product, which will exhibit material capabilities desired by a consumer, as well as properties which allow for the creation of apertures in the material.

As another example, a product may be designed to exhibit predetermined viscoelasticity, elasticity, yield, hardening, and/or other material behaviors. Since each of these parameters may be interrelated, designing a material that exhibits each of the desired properties may be difficult, if not impossible, to adequately design using current strategies. As such, many of these current strategies rely on creating numerous physical prototypes that attempt to address the material properties one (or a few) at a time.

### SUMMARY OF THE INVENTION

Included are systems and methods for material modeling and prediction. Some systems and methods include determining test data for a test material. The test material may exhibit a plurality of interrelated material behaviors and the test data may relate to the plurality of interrelated material behaviors. Additionally, some systems and methods include providing the test data to a user, receiving a process from the user for decoupling at least two of the plurality of interrelated material behaviors, and in response to receiving the process for decoupling at least two of the plurality of interrelated material behaviors, fitting a plurality of modules to simulate the test material. In some systems and methods, each of the plurality of modules relates to at least one of the plurality of interrelated material behaviors. Further, some systems and methods include assembling a simulated model of the test material from the plurality of modules, simulating a physical test of the simulated model and comparing a test result to a predetermined standard, and providing the test result for display. The test result may include data for a plurality of environmental conditions, such as temperature, moisture, etc.

Also included are systems. The system may include a memory component which stores logic that, when executed by the system, causes the system to: determine test data for a test material, provide the test data to a user, and receive a process from the user for decoupling at least two of the plurality of interrelated material behaviors. In response to receiving the process for decoupling at least two of the plurality of interrelated material behaviors, the logic may cause the system to fit a plurality of modules to simulate the test material, where each of the plurality of modules relates to at least one of the plurality of interrelated material behaviors. Similarly, the logic may cause the system to assemble a simulated model of the test material from the plurality of modules, simulate a physical test of the simulated model, compare a test result to a predetermined standard, and provide the test result for display.

Also included are non-transitory computer-readable mediums. The non-transitory computer-readable medium includes logic that causes a computing device to determine test data for a test material, the test material exhibiting a plurality of interrelated material behaviors; provide the test data to a user; and receive a process from the user for decoupling at least two of the plurality of interrelated material behaviors. In response to receiving the process for decoupling at least two of the plurality of interrelated material behaviors, the logic causes the computing device to fit a plurality of modules to simulate the test material, each of the plurality of modules relating to at least one of the plurality of interrelated material behaviors. Additionally, the logic causes the computing device to assemble a simulated model of the test material from the plurality of modules, simulate a physical test of the simulated model, compare a test result to a predetermined standard, and utilize an output of the physical test to form an input for a failure module parameter of the simulated model, wherein the failure module parameter are determined, based on results from the simulated model and the test data. The logic may cause the computing device to incorporate the failure module parameter into the simulated model and provide the test result for display.

### BRIEF DESCRIPTION OF THE DRAWINGS

It is to be understood that both the foregoing general description and the following detailed description describe various systems and methods and are intended to provide an overview or framework for understanding the nature and character of the claimed subject matter. The accompanying drawings are included to provide a further understanding of the various systems and methods, and are incorporated into and constitute a part of this specification. The drawings illustrate various systems and methods described herein, and together with the description serve to explain the principles and operations of the claimed subject matter.

FIG. 1 depicts a computing device for material modeling and prediction, according to systems and methods disclosed herein;

FIG. 2 depicts a user interface for fitting a test material to one or more modules, according to systems and methods disclosed h according to systems and methods disclosed herein;

FIGS. 3A and 3B depict a user interface for providing a material parameter summary, according to systems and methods disclosed herein;

FIG. 4 depicts a user interface for material shifting, according to systems and methods disclosed herein;

FIG. 5 depicts a user interface for fitting a test material to a viscoelasticity module, according to systems and methods disclosed herein;

FIGS. 6A and 6B depict a user interface for fitting the test material to a Mullins Effect module, according to systems and methods disclosed herein;

FIGS. 7A, 7B, 7C, and 7D depict a user interface for fitting the test material to a viscoplasticity module, according to systems and methods disclosed herein;

FIG. 8 depicts a flowchart for modeling and predicting material behaviors, according to systems and methods disclosed herein;

FIG. 9 depicts a flowchart for simulating a model and a physical test to determine material behaviors, according to systems and methods disclosed herein;

### DETAILED DESCRIPTION OF THE INVENTION

Systems and methods disclosed herein include systems and methods for material modeling and prediction. Specifically, systems and methods may be configured to determine a test material and perform simulated tests of the material properties of that test material to determine whether the test material is sufficient for its intended purpose. Depending on the particular system and/or method, the test material may be composed of polymer, steel, composite, and/or other materials. If the test material exhibits the desired material properties, physical tests of the material may be performed. If the test material does not exhibit the desired material properties for its intended purpose, the test material may be redesigned and re-simulated to predict performance under the expected environment that the material will be subject.

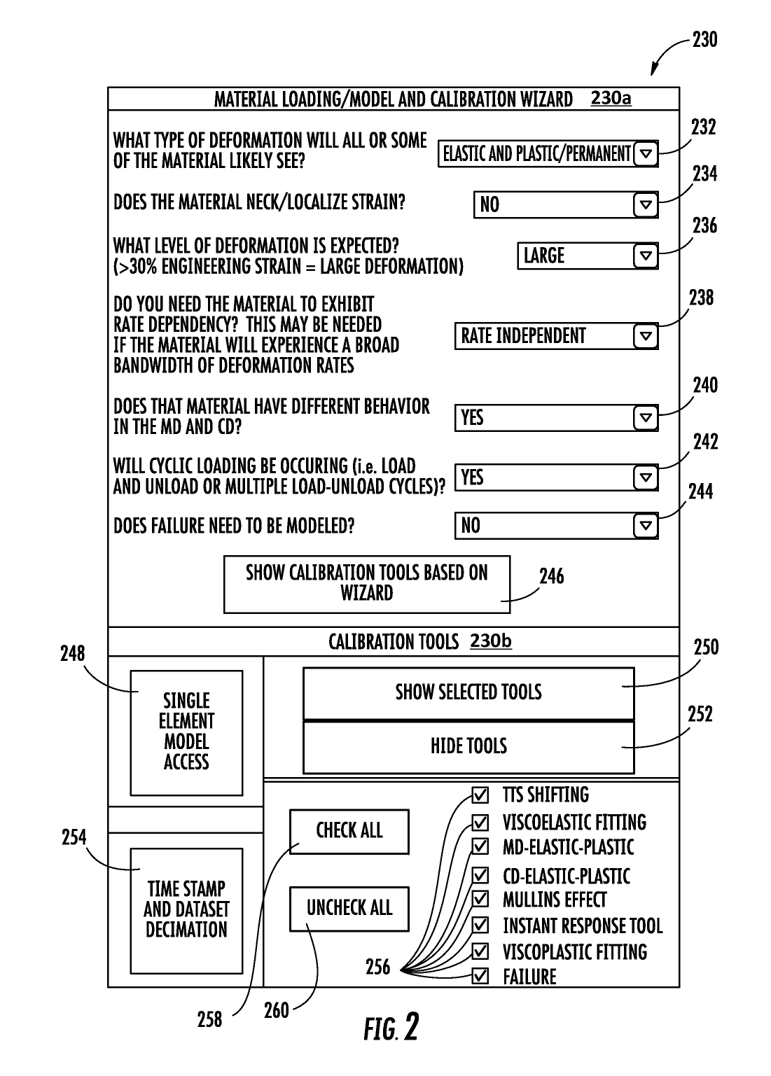

As an example, a polymer may be desired for use in a product. The product may have one or more desired and/or necessary performance characteristics, such as deformability, elasticity, longevity, etc. Accordingly, a material designer may first design a test material that the material designer may believe will exhibit the desired performance characteristics. The test material may be designed according to a plurality of material parameters, such as viscoelasticity, elasticity, yield, hardening, viscoplasticity, and/or other material parameters. Accordingly, the material designer may identify the material properties of the test material and utilize the material properties to fit the material against a plurality of modules that are associated with each of the identified material parameters. The modules may include data and/or algorithms that may be used to predict the behavior of the particular material, based on the material characteristics. Examples of the modules discussed herein are elasticity, damage, viscoelasticity, etc. and are depicted in the user interfaces of FIGS. 2-7D as data that may be used to populate those respective user interfaces. Once the modules are fit to the material, a simulated model of the material may be created, which utilizes each of the modules. The simulated model may then be subjected to a simulated physical test to determine whether the test material meets one or more performance thresholds. If not, the test material may be redesigned. If the test material meets the predetermined thresholds, test data for the simulated physical test may be provided to the material designer and/or actual physical tests may be performed on a prototype of the test material.

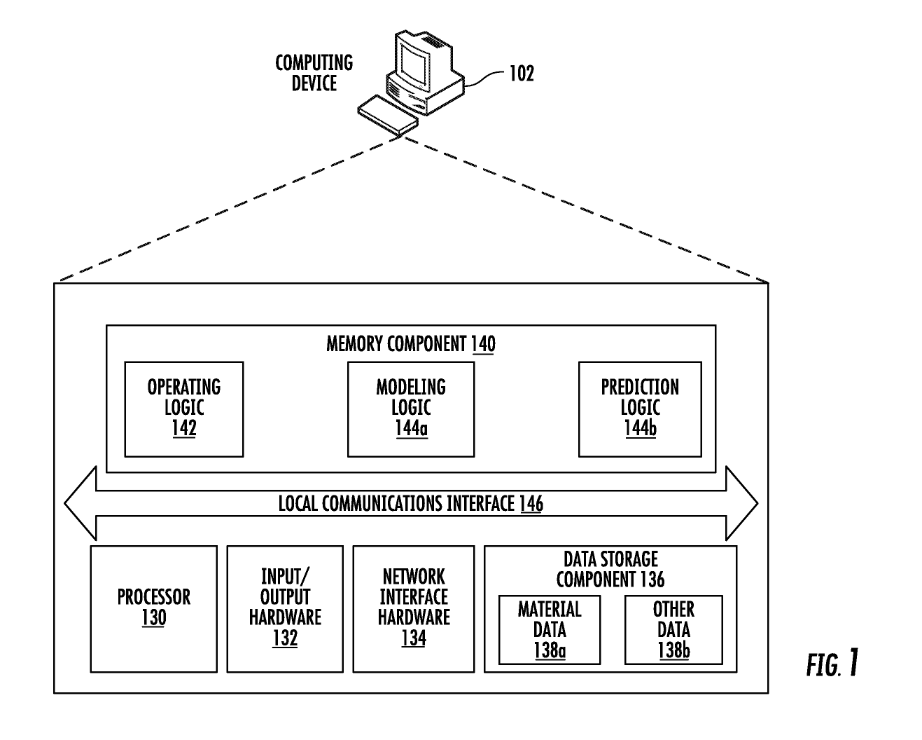

Referring now to the drawings, FIG. 1 depicts a computing device 102 for material modeling and prediction, according to systems and methods disclosed herein. In the illustrated environment, the computing device 102 includes a processor 130, input/output hardware 132, network interface hardware 134, a data storage component 136 (which stores material data 138a and other data 138b), and the memory component 140. The memory component 140 may be configured as volatile and/or nonvolatile memory and, as such, may include random access memory (including SRAM, DRAM, and/or other types of RAM), flash memory, registers, compact discs (CD), digital versatile discs (DVD), and/or other types of non-transitory computer-readable mediums. Depending on the particular configuration, these non-transitory computer-readable mediums may reside within the computing device 102 and/or external to the computing device 102.

Additionally, the memory component 140 may be configured to store operating logic 142, modeling logic 144a, and prediction logic 144b, each of which may be embodied as a computer program, firmware, and/or hardware, as an example. A local communications interface 146 is also included in FIG. 1 and may be implemented as a bus or other interface to facilitate communication among the components of the computing device 102.

The processor 130 may include any processing component operable to receive and execute instructions (such as from the data storage component 136 and/or memory component 140). The input/output hardware 132 may include and/or be configured to interface with a monitor, keyboard, mouse, printer, camera, microphone, speaker, and/or other device for receiving, sending, and/or presenting data. The network interface hardware 134 may include and/or be configured for communicating with any wired or wireless networking hardware, a satellite, an antenna, a modem, LAN port, wireless fidelity (Wi-Fi) card, WiMax card, mobile communications hardware, and/or other hardware for communicating with other networks and/or devices. From this connection, communication may be facilitated between the computing device 102 and other computing devices.

Similarly, it should be understood that the data storage component 136 may reside local to and/or remote from the computing device 102 and may be configured to store one or more pieces of data for access by the computing device 102 and/or other components. In some systems and methods, the data storage component 136 may be located remotely from the computing device 102 and thus accessible via a network. Or, the data storage component 136 may merely be a peripheral device external to the computing device 102.

Included in the memory component 140 are the operating logic 142, the modeling logic 144a and the prediction logic 144b. The operating logic 142 may include an operating system and/or other software for managing components of the computing device 102. Similarly, the modeling logic 144a may be configured to cause the computing device 102 to model one or more material parameters of a test material. Additionally, the prediction logic 144b may reside in the memory component 140 and may be configured to cause the processor 130 to predict material behaviors, based on the material parameters and modules that are fit to the test material, as described in more detail, below.

It should be understood that the components illustrated in FIG. 1 are merely exemplary and are not intended to limit the scope of this disclosure. While the components in FIG. 1 are illustrated as residing within the computing device 102, this is merely an example. In some systems and methods, one or more of the components may reside external to the computing device 102. It should also be understood that, while the computing device 102 in FIG. 1 is illustrated as a single system, this is also merely an example. In some systems and methods, the modeling functionality is implemented separately from the prediction functionality, which may be implemented with separate hardware, software, and/or firmware.

FIG. 2 depicts a user interface 230 for fitting a test material to one or more modules, according to systems and methods disclosed herein. Specifically, in designing a material that meets predetermined performance guidelines, a material designer may identify a test material, simulate the test material, and determine material properties of the test material. Accordingly, the user interface 230 may assist in determining the material properties, as well as fit the test material to one or more material property modules. The user interface 230 may comprise a material loading/model and calibration wizard 230a as well as calibration tools 230b. Specifically, the user interface 230 may be utilized for inputting the test material into the computing device 102. Accordingly, field 232 may be configured to receive a type of deformation to which the test material will be subject. As an example, the test material may be subject to elastic deformation, plastic deformation, both elastic and plastic deformation, and/or other types of deformation. Similarly field 234 is provided for receiving user input related to whether the test material localizes strain. Field 236 is also included in the user interface 230 and may be provided for identifying a level of deformation that is expected for the test material. Field 238 may be utilized for identifying whether the test material will exhibit rate dependency.

Field 240 may be utilized for determining whether the test material will exhibit different properties in the machine direction (MD) and the cross direction (CD). As discussed in more detail below, some materials exhibit different material properties in the direction of production (MD), as opposed to 90 degrees from the direction of production (CD). As an example, if the test material is a sheet material that is extruded from a production machine, the machine direction will be the direction that the test material is being extruded. Accordingly, the cross direction is the direction 90 degrees from the direction of extrusion.

Field 242 is also included in the user interface 230 and may be utilized to identify whether cyclic loading of the test material will occur. Field 244 may be utilized to determine whether failure is to be modeled with the test material. Also included is a “show calibration tools” option 246 for providing the calibration tools 230b of the test material to the user.

The calibration tools 230b are listed below and may include a “single element model access” option 248, a “show selected tools” option 250, a “hide tools” option 252, and a “time stamp and dataset decimation” option 254. Also included are a variety of options 256 for selecting various fitting modules that may be utilized for the test material. As an example, options for time-temperature superposition (TTS) shifting, viscoelasticity fitting, MD-elastic-plastic, CD-elastic-plastic, Mullins Effect, instance response tool, viscoplastic fitting, and failure are provided. A “check all” option 258 and an “uncheck all” option 260 are also provided.

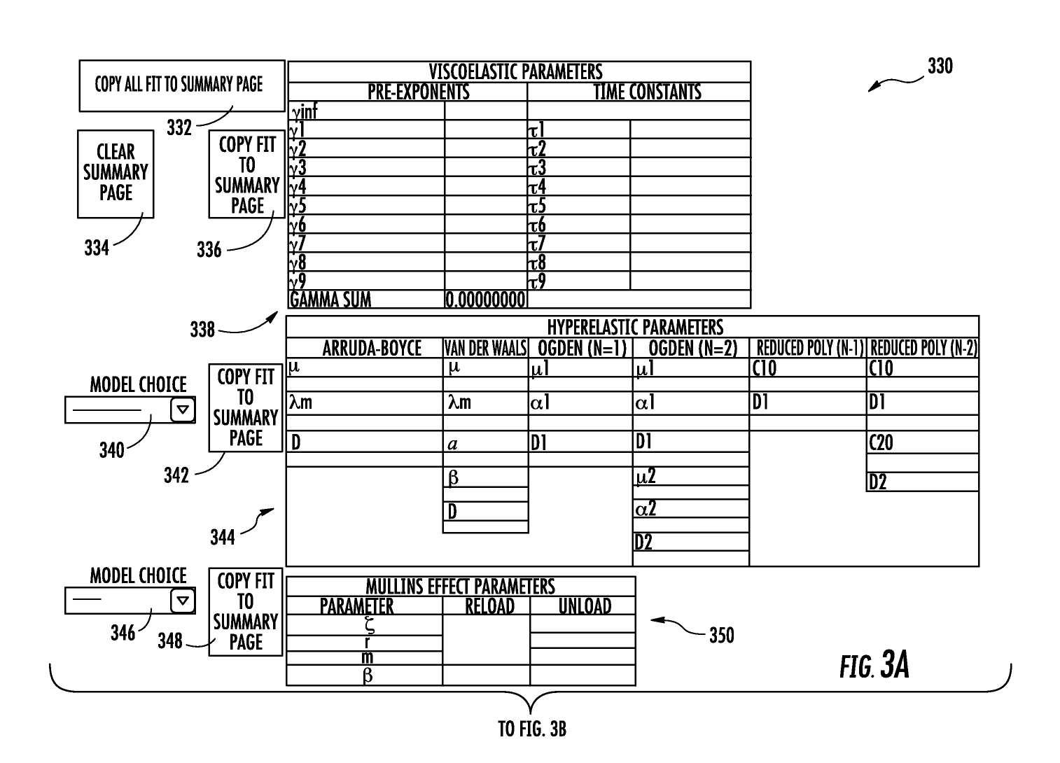

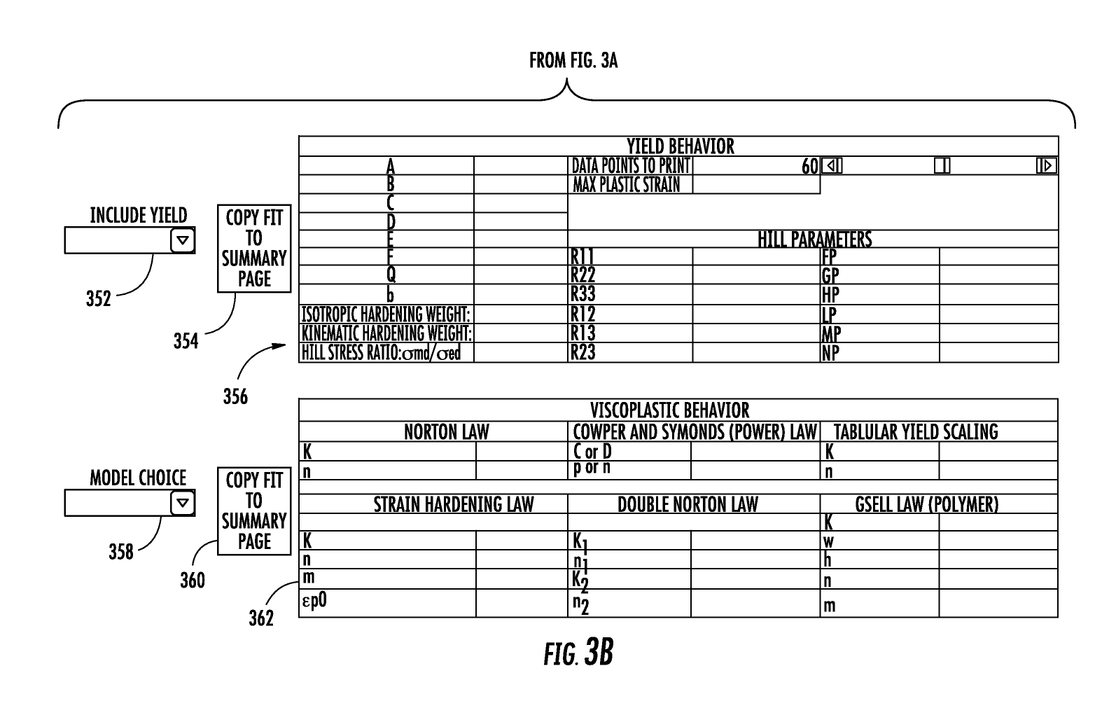

FIGS. 3A and 3B depict a user interface 330 for providing a material parameter summary, according to systems and methods disclosed herein. As illustrated in FIG. 3A, the user interface 300 includes a viscoelastic parameters chart 338 for receiving one or more modules that provide understood behaviors and/or parameters of a known material. The viscoelastic parameters chart 338 may include a pre-exponents column and a time constants column, which allow for receipt of the requested viscoelastic module and/or other components. Also included in the user interface 330 are a “copy all fits to summary page” option 332, a “clear summary page” option 334, and a “copy fit to summary page” option 336. In response to selection of the “copy all fits to summary page” option 332, values that are provided in FIGS. 3-7 (and/or other pages) may automatically populate the fields depicted in the user interface 330. Similarly, the “copy fit to summary page” option 336 may operate similarly, except the values that are copied are limited to the viscoelastic parameters.

Also included is an elastic and/or hyperelastic chart 344, which may receive Arruda-Boyce values, Van der Waals values, Odgen (N=1) values, Ogden (N=2) values, reduced polynomial (N=1) values, and reduced polynomial (N=2) values. The chart 344 may have columns for these values. Additionally included is a model choice option 340 for the material designer to determine which model is to be used for the hyperelastic parameters portion of the material design. Also included is a “copy fit to summary page” option 342.

The user interface 330 also includes a Mullins Effect chart 350, which includes a parameter column, a reload column, and an unload column for defining a module fit. Also included are a “model choice” option 346 and a “copy fit to summary page” option 348. As shown in FIG. 3B, a yield behavior chart 356 is also provided, which includes hardening module parameter fields such as fields for maximum plastic strain, isotropic hardening weight, kinematic hardening weight, hill stress ratio, hill parameters, etc. A yield inclusion field 352 and a “copy fit to summary page” option 354 are also provided. A viscoplastic behavior chart 362 is also provided for receiving viscoplastic aspects of the test material. Specifically, columns for Norton's Law, Cowper and Symonds (Power) Law, tabular yield scaling, strain hardening law, Double Norton Law, and Gsell Law (Polymers) are provided. Also included are a “model choice” option 358 and a “copy fit to summary page” option 360.

From the data received in the user interface 330, graphical and/or other data may be computed to provide a fit for each of the selected material parameters. As an example, a viscoelastic fit may be provided, which may include a normalized stress value, versus time. Marlow data may be provided as a plot of engineering stress versus elastic engineering strain. Mullins Effect data may be provided, as well as yield behavior as a long term true yield stress versus true plastic strain. A viscoplastic response may be provided as a fitted plastic strain rate versus a plastic strain rate. Other data may also be provided.

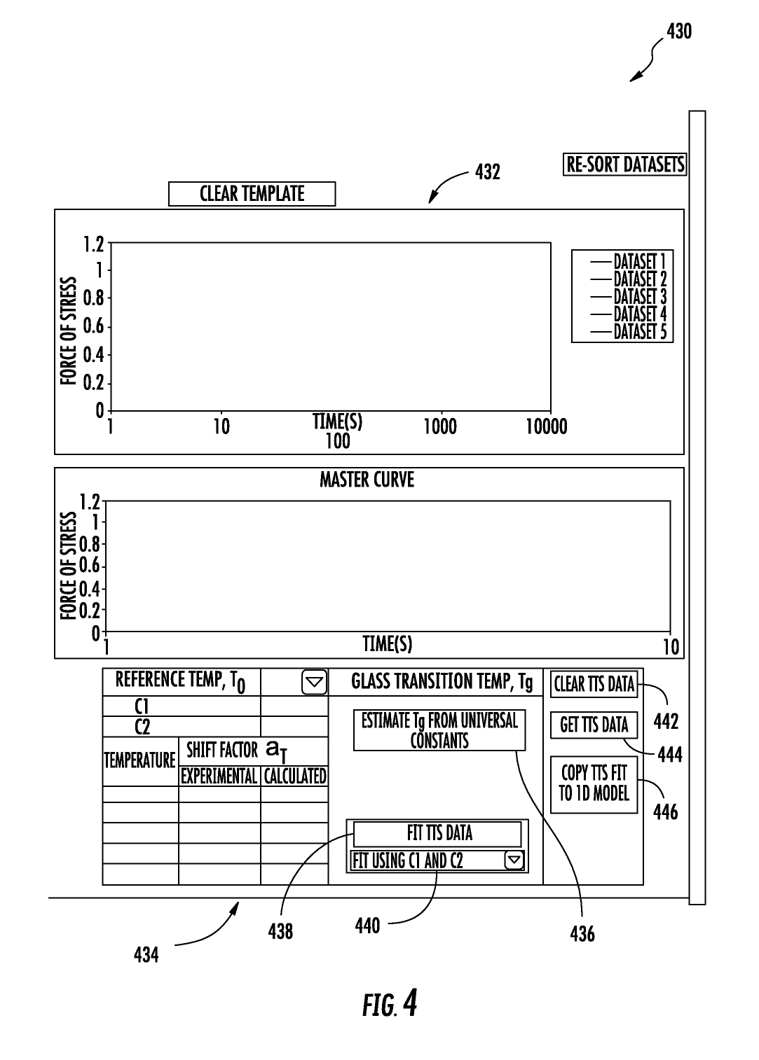

It should be understood that the user interface 330 of FIG. 3 provides a summary page. The user interfaces 430, 530, 630, and 730 in FIGS. 4-7 may provide more explicit details of the data provided in the user interface 330. Similarly, as illustrated in the user interface 330 and the other user interfaces, options for sharing data among the user interfaces are provided.

FIG. 4 depicts a user interface 430 for material shifting, according to systems and methods disclosed herein. Specifically, the user interface 430 may be provided in response to selection of the TTS (time-temperature superposition) shifting option from FIG. 2. Regardless, the user interface 430 provide a material shifting module for fitting the test material that includes a plot of shifted time versus force or stress for a plurality of data sets, which may be provided in the graphical area 432. Additionally, a chart 434 may be provided, which provides fields for reference temperature, a material temperature, a shift factor, and a glass transition temperature. Also included are an “estimate glass transition temperature (Tg)” option 436, a “fit the TTS data” option 438, a “fit using predetermined aspects” option 440, a “clear TTS data” option 442, a “get TTS data” option 444, and a “copy TTS fit to 1-dimensional model” option 446. Additionally, some systems and methods may include fields for providing data points to exclude from the graphical area 432.

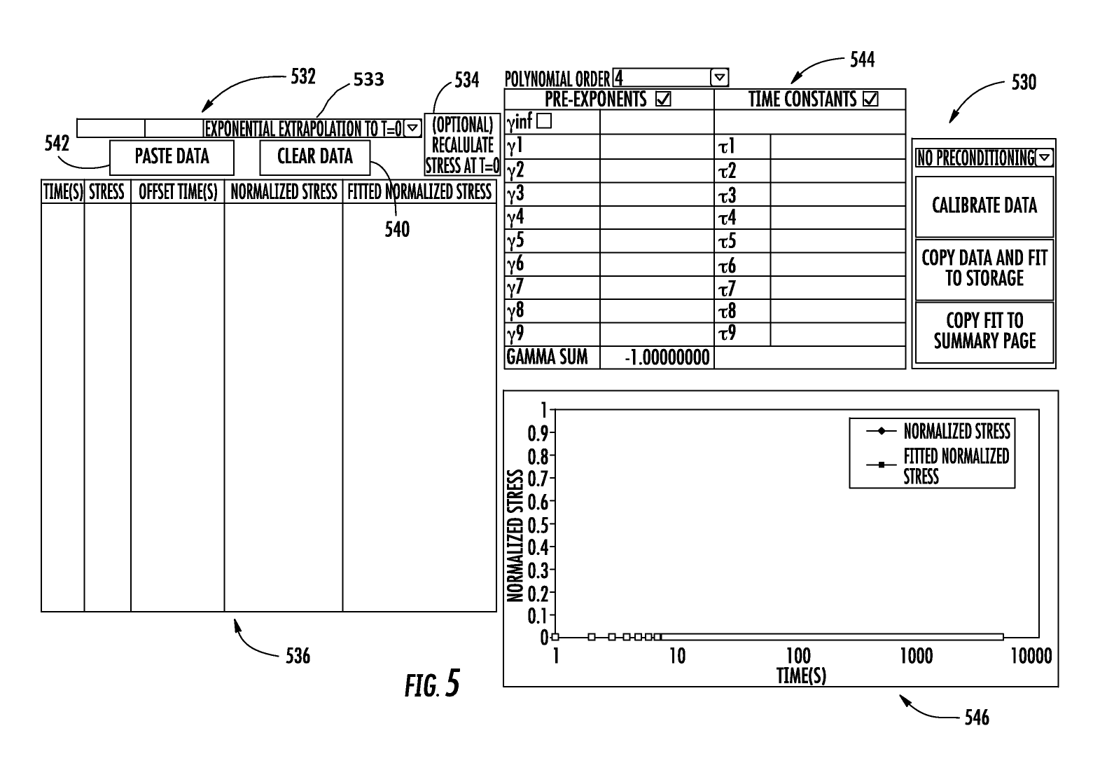

FIG. 5 depicts a user interface 530 for fitting the test material to a viscoelasticity module, according to systems and methods disclosed herein. As illustrated, the user interface 530 may be utilized to provide data related to viscoelastic fitting of the test material based on an understood viscoelasticity module. Specifically, the user interface 530 includes a normalization method section 532, which may include fields for time and stress, as well as a “normalization method” option 533. A “recalculate” option 534 may also included and may recalculate the stress values at time=0. Additionally, a table section 536 is included and is configured for receiving times, stress, offset times, normalized stress, and fitted normalized stress. Also included are a “paste data” option 542 and a “clear data” option 540. An additional chart 544 may also provided for receiving pre-exponents, time constants, and a polynomial order. A graphical representation 546 may be provided, which includes a normalized stress versus time.

Additionally, some systems and methods may be configured to precondition the received data, such as providing options to calibrate the data, copy and fit the data to storage, and/or copy and fit the data to the user interface 330 (FIG. 3). Similarly, some systems and methods may be configured to provide storage for one viscoelastic data of one or more different data sets. In some systems and methods, the data may be provided as a user interface with chart data and/or graphical data; however, this is just an example.

Similarly, some systems and methods may be configured to provide data and/or analysis of the machine direction elastic-plastic properties of the test material. Systems and methods may also be configured to provide data and/or analysis of the cross direction elastic-plastic properties of the test material. Stress-strain data of the test material in each of these directions may be provided and fit to the test material. Examples include engineering strain, engineering stress, instant engineering stress, long term engineering stress, true strain, true plastic strain, true elastic strain, engineering elastic strain, and instant engineering stress.

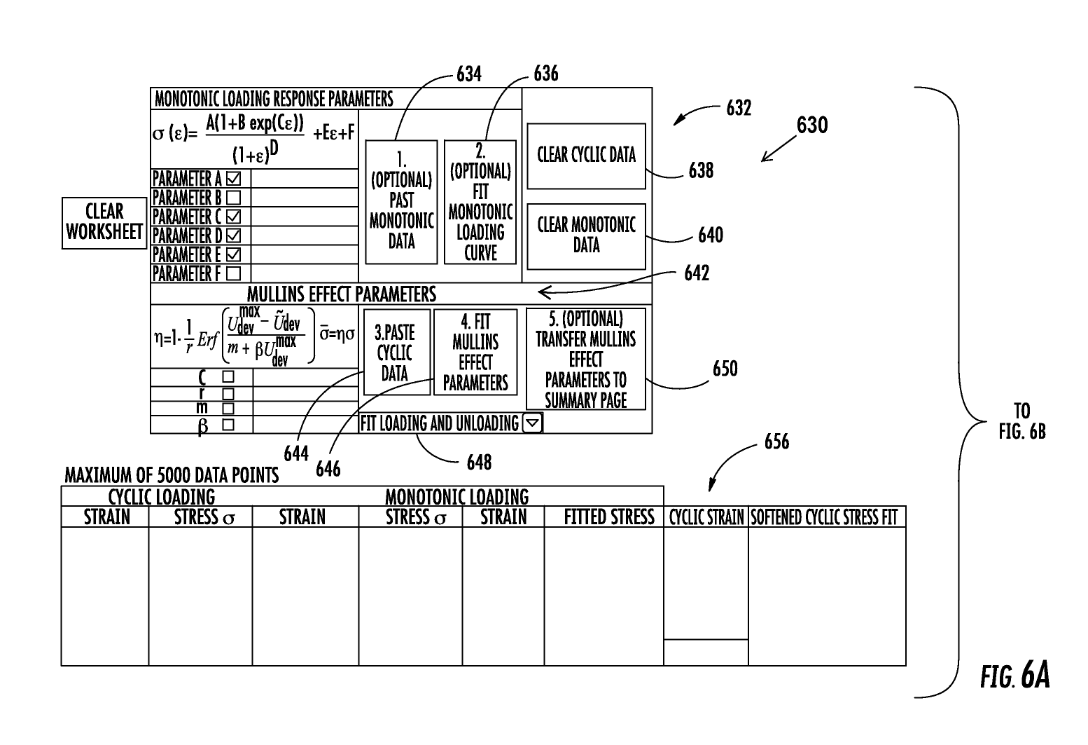

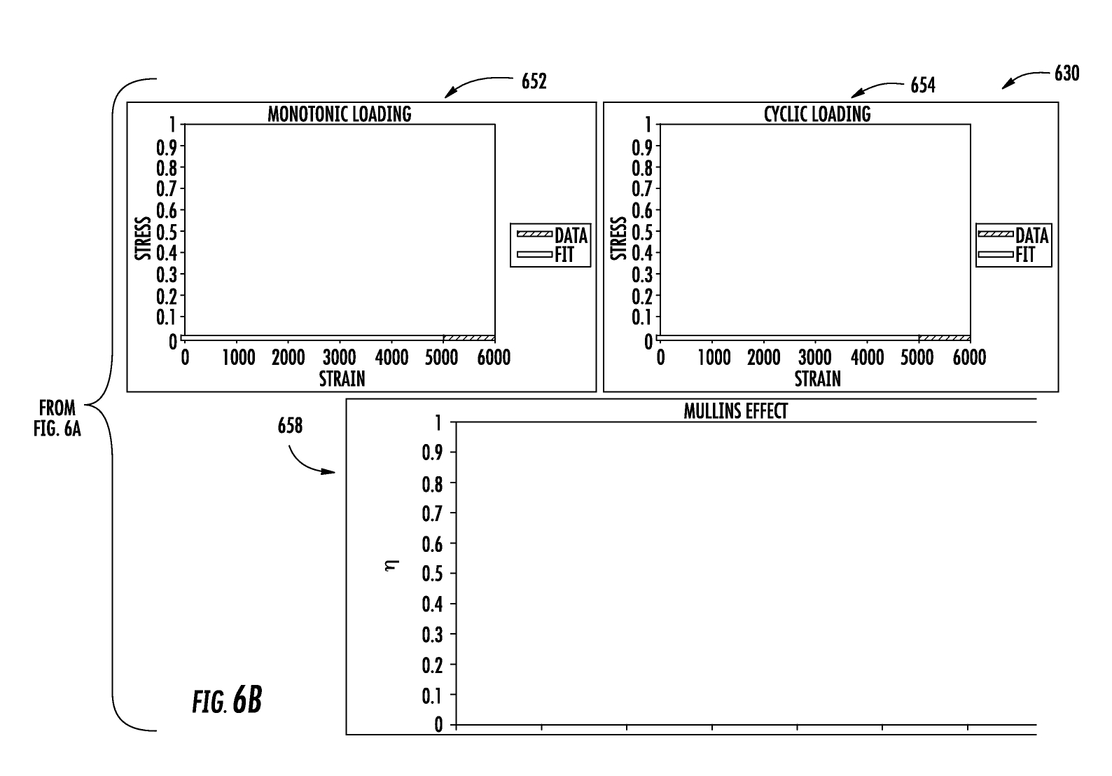

FIGS. 6A and 6B depict a user interface 630 for fitting the test material to a Mullins Effect module, according to systems and methods disclosed herein. As illustrated, in fitting the test material to the Mullins Effect module, the user interface may be provided that includes a monotonic loading response parameters section 632. The monotonic loading response parameters section 632 may include a “past monotonic data” option 634 for pasting the monotonic data of the test material into the user interface 630. A “fit monotonic loading curve” option 636 may be provided for fitting the monotonic loading curve to the test material. A “clear cyclic data” option 638 and a “clear monotonic data” option 640 may also be provided for clearing the data from the user interface 630.

Additionally included in FIG. 6A is a Mullins Effect parameter section 642 that may include a “paste cyclic data” option 644, a “fit Mullins Effect parameters” option 646, a “transfer Mullins Effect parameters to summary page” option 650 (user interface 330 from FIG. 3), and a “fit loading and unloading” option 648. As such, in the monotonic loading response parameters section 632 and the Mullins Effect Parameter section 642, various parameters for the test material may be received. Based on the data received, an algorithm may be performed on that data, which may provide one or more data points, which may be provided in the data points section 656. The data points section 656 may include data points for cyclic loading, such as strain and stress. The data points section 656 may additionally include data points for monotonic loading, such as stress, strain, and fitted stress. Data points for cyclic strain and softened cyclic stress fit may also be provided.

As illustrated in FIG. 6B, the user interface 630 also includes a monotonic loading plot 652, a cyclic loading plot 654, and a Mullins Effect plot 658. The plots 652, 654, and 658 may be configured for providing a graphical representation of the data and fit performed for the test material. Additionally, some systems and methods may be configured for receiving and/or determining instant response of the test material. As an example, instantaneous stress and strain may be determined for the test material and plotted to determine the rate response, as well as the instantaneous response of the test material.

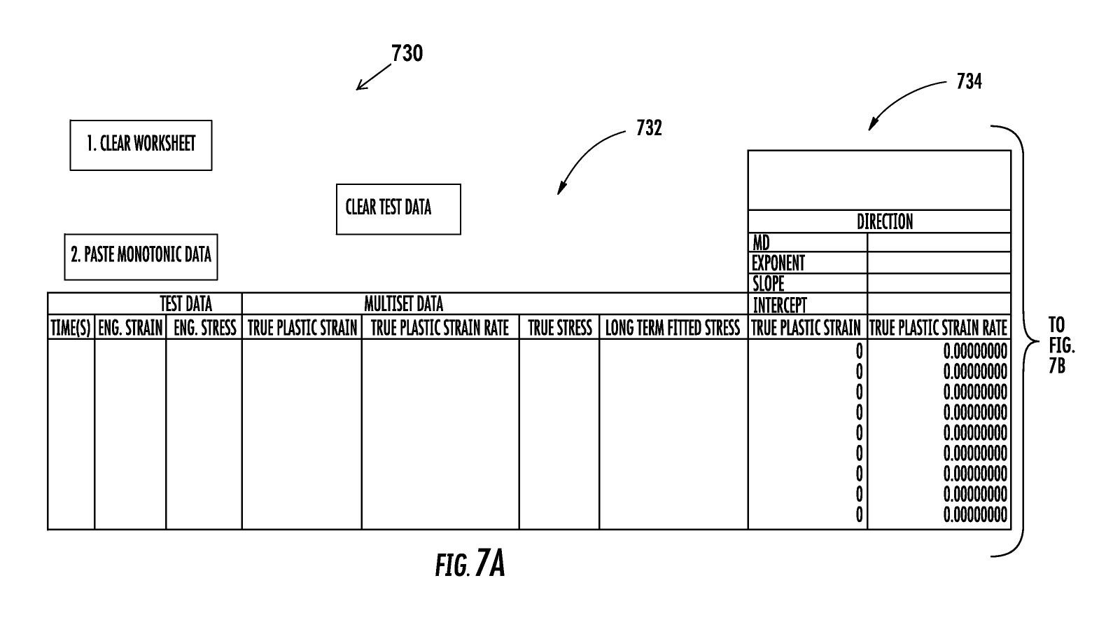

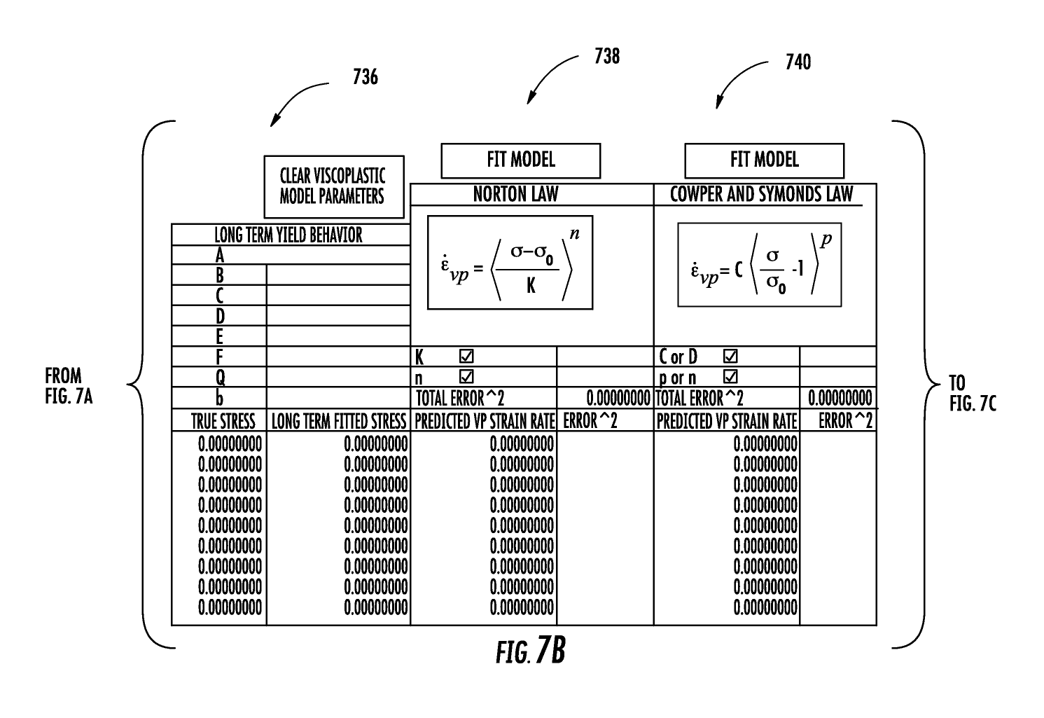

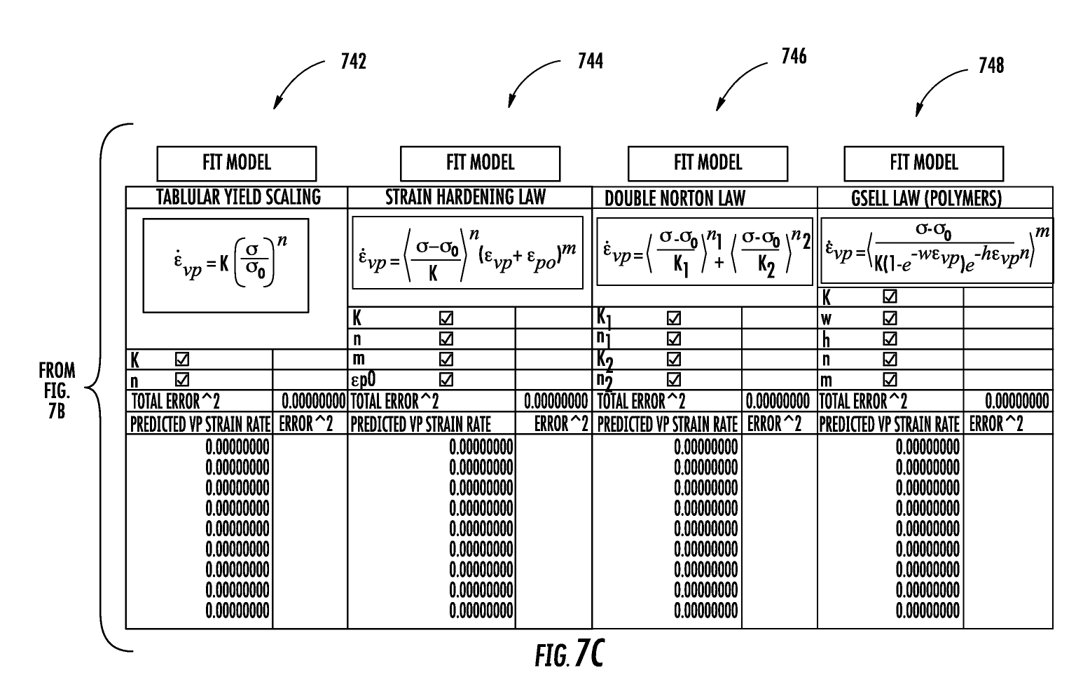

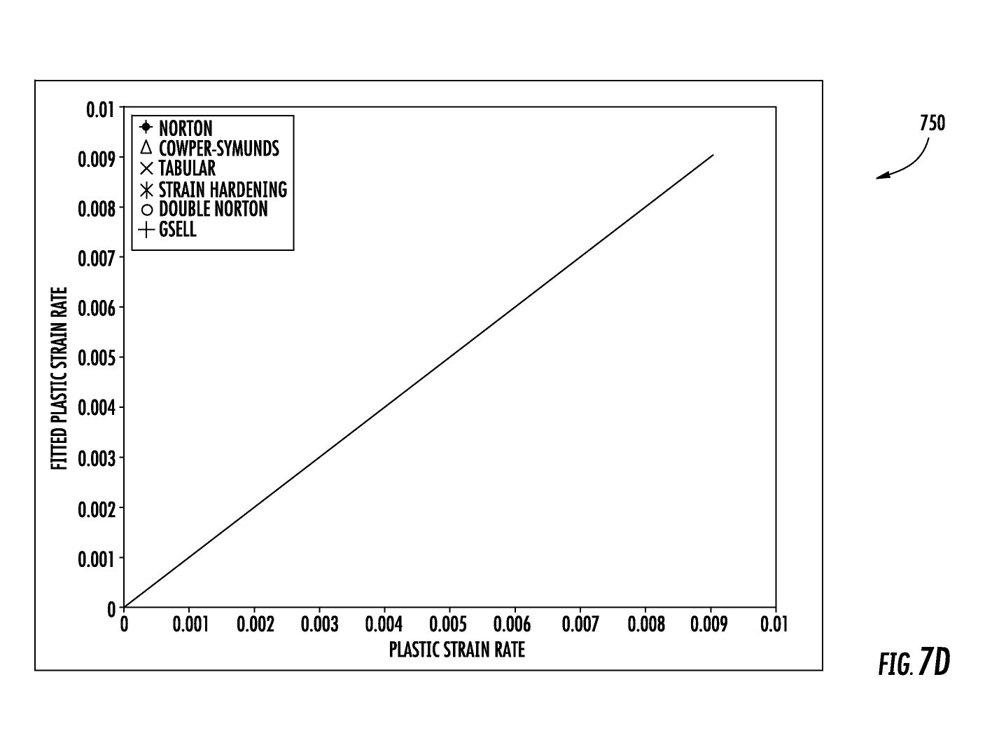

FIGS. 7A, 7B, 7C, and 7D depict a user interface 730 for fitting the test material to a viscoplasticity module, according to systems and methods disclosed herein. As illustrated, the user interface 730 includes a plurality of fields for determining and fitting the viscoplasticity parameters with the test material. Specifically, in section 732, test data may be provided, such as times, engineering strain, and engineering stress. Multiset data storage may also be provided and include true plastic strain, the true plastic strain rate, true stress, and long term fitted stress. Additionally, a direction and yield section 734 may be provided, which provides a direction option, as well as an exponent, slope, and intercept fields. Options here may comprise “clear worksheet,” “paste monotonic data,” “clear test data,” or the like.

As illustrated in FIG. 7B, a long term yield behavior section 736 is provided. A true plastic strain column is also included, as well as a true plastic strain rate column, a true stress column, and a long term fitted stress column. Also included is a Norton Law section 738, which includes a “fit model” option, as well as an equation for determining the Norton Law parameters. Fields for “K,” “n,” and “total error” are also provided, which may be utilized for solving the equation. Also included are a predicted viscoplasticity strain rate column and an error column A Cowper and Symonds Law section 740 is also included, which includes an equation for determining the Cowper and Symonds Law parameters. A “fit model” option is also provided, as well as a “c or D” field, a “p or n” field, and a “total error” field for solving the equation. These variables may be utilized in the algorithm above for generating the data points. A predicted viscoplasticity strain rate and error are also provided for the Cowper and Symonds Law section 740.

As illustrated n FIG. 7C, a tabular yield section 742 may be provided and may include a fit model option and an equation for determining the desired tabular yield scaling parameters. A “K” field, an “n” field, and a “total error” field are also provided for solving the equation. A predicted viscoplasticity strain rate and an error column are also provided. A strain hardening law section 744 is also provided and includes a straining hardening law equation, as well as fields such as “K,” “n,” “m,” and “εₚ₀” for solving the equation. A total error field is also provided. Also included are a predicted viscoplasticity strain rate column and an error column A double Norton Law section 746 is also included in the user interface 730 and includes a fit model option, as well a double Norton Law equation. Fields “K₁,” “n₁,” “K₂,” “n₂” for solving the equation and a “total error” field are also provided. A predicted viscoplasticity strain rate and an error column are also included. Additionally, the user interface 730 includes a Gsell law (polymers) section 748, which includes a “fit model” option, as well as a Gsell Law equation and fields “K,” “w,” “h,” “n,” and “m” for solving the equation. A “total error” field is also provided. Columns for predicted viscoplasticity strain rate and error are also provided.

As illustrated in FIG. 7D, from the information provided and/or calculated in the sections 732-748, a graphical representation of the respective data points may be provided in graphical section 750. The graphical section may be provided with fitted plastic strain rate plotted against plastic strain rate.

It should be understood that while the user interfaces 230-730 depict various systems and methods that be utilized for modeling and/or predicting material behaviors, these are merely examples. As a further example, one or more user interfaces for determining failure and/or other material behaviors may be provided.

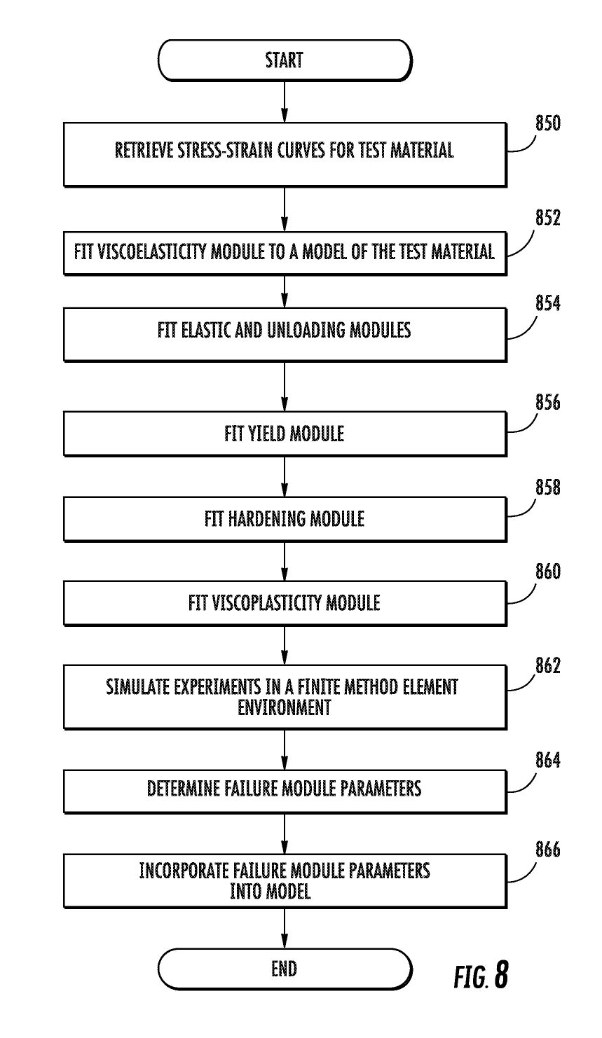

FIG. 8 depicts a flowchart for modeling and predicting material behaviors, according to systems and methods disclosed herein. As illustrated in block 850, a stress-strain curve may be retrieved for a test material. As an example, stress-strain curves may include tension, compression curves at a variety of strain rates, cyclic tension/compression curves, and stress/relaxation curves. Additionally, in some systems and methods, the stress-strain curve includes at least one of the following: a tension-compression curve at a variety of strain rates, a cyclic tension-compression curve, and a stress-relaxation curve. Regardless, in block 852, a viscoelasticity module may be fit to a model of the test material. In some systems and methods, the stress/relaxation stress-strain curve may be utilized to fit the material parameters for viscoelasticity to the test material. Examples of the module may be illustrated in the user interface 530 (FIG. 5) and/or utilizing a Prony series. In block 854, elastic and unloading modules may be fit to the model. As an example, a cyclic stress-strain curve may be utilized to fit the elastic and unloading module. The viscoelasticity parameter determined in block 852 may be utilized for this determination. Depending on the particular system and/or method, the elastic module may be configured as a hyperelastic module. Regardless, examples of elastic modules include, but are not limited to Arruda-Boyce model and Neo Hookean model. An example of an unloading module includes but is not limited to the Mullins Effect.

In block 856, a yield module may be fit to the model. It should be understood that in some systems and methods, the yield module may utilize a cyclic stress-strain curve in an anisotropic direction. In block 858, a hardening module may be fit to the model. The stress-strain curve may again be utilized to fit the hardening parameters. Examples of the hardening module include, but are not limited to isotropic hardening and kinematic hardening. In block 860, a viscoplasticity module may be fit to the model. The stress-strain curve may again be utilized to fit the viscoplastic parameters. In this block, the total strain may be decomposed to elastic and plastic strain, as determined from the previous blocks. In block 862, experiments on the test material and fitted modules may be simulated in a finite element method environment. Specifically, once all the model parameters are determined and input into the test material model, experiments may be simulated in a finite element environment. Examples include, but are not limited to simulating a uniaxial test in the MD at a strain rate, simulating a uniaxial test in the CD at a strain rate, etc. In block 864, failure may be determined for the test material. Specifically, some of the outputs of the above simulations (e.g. strain rates, strains) form an input to the failure module of the test material model. The failure module parameters may be determined based on results from the simulations and stress-strain curves, such as failure strains and times. In block 866, a failure module may be incorporated into the model.

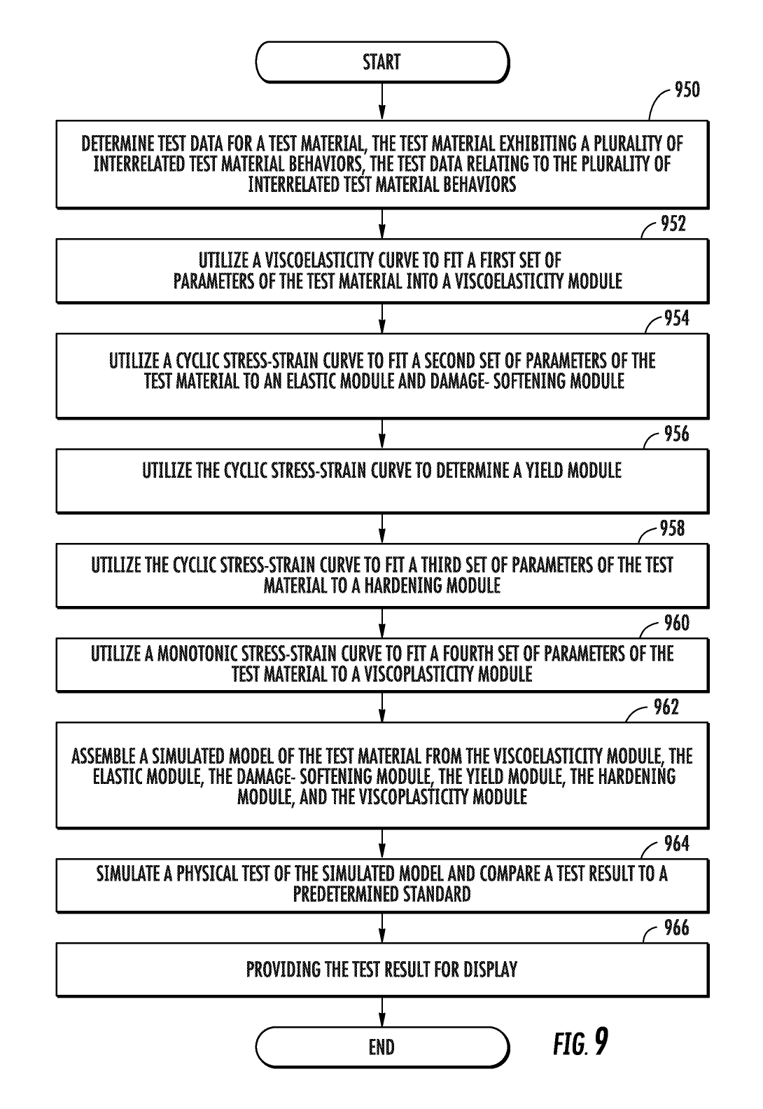

FIG. 9 depicts a flowchart for simulating a model and a physical test to determine material behaviors, according to systems and methods disclosed herein. As illustrated in block 950, test data for a test material may be determined The test material may exhibit a plurality of interrelated material behaviors. The test data may be related to the plurality of interrelated material behaviors. In block 952, a viscoelasticity curve may be utilized to fit a first set of parameters of the test materials into a viscoelasticity module. In block 954, the cyclic stress-strain curve may be utilized to fit a second set of parameters of the test material to an elastic module and damage softening module. In block 956, the cyclic stress-strain curve may be utilized to determine a yield module. In block 958, the cyclic stress-strain curve may be utilized to fit a third set of parameters of the test material to a hardening module. In block 960, a monotonic stress-strain curve may be utilized to fit a fourth set of parameters of the material to a viscoplasticity module. In block 962, a simulated model of the test material may be assembled from the viscoelasticity module, the elastic module, the damage-softening module, the yield module, the hardening module, and the viscoplasticity module. In block 964, a physical test of the simulated model may be simulated. The result of the physical test may be compared to a predetermined standard result. In block 966, the test result may be provided for display.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular systems and methods of the present invention have been illustrated and described, it would be understood to those skilled in the art that various other changes and modifications can be made without departing from the spirit and scope of the invention. It is therefore intended to cover in the appended claims all such changes and modifications that are within the scope of this invention.

What is claimed is:

1. A system for material modeling, comprising:
a memory component that stores logic that, when executed by the system, causes the system to perform at least the following:
determine test data for a test material, the test material exhibiting a plurality of interrelated material behaviors, the test data relating to the plurality of interrelated material behaviors;
provide the test data to a user;
receive a process from the user for decoupling at least two of the plurality of interrelated material behaviors;
in response to receiving the process for decoupling at least two of the plurality of interrelated material behaviors, fit a plurality of modules to simulate the test material, each of the plurality of modules relating to at least one of the plurality of interrelated material behaviors;
assemble a simulated model of the test material from the plurality of modules;
simulate a physical test of the simulated model and compare a test result to a predetermined standard; and
provide the test result for display.

2. The system of claim 1, wherein the test data comprises a stress-strain curve for the test material, the stress-strain curve comprising at least one of the following: a tension-compression curve at a variety of strain rates, a cyclic tension-compression curve, and a stress-relaxation curve.

3. The system of claim 1, wherein the plurality of modules comprises at least one of the following: a viscoelasticity module, a hyperelastic module, an unloading module, a yield module, a hardening module, and a viscoplasticity module.

4. The system of claim 1, wherein the logic further causes the system to perform at least the following:
utilize an output of the physical test to form an input for a failure module parameter of the simulated model, wherein the failure module parameter is determined, based on results from the simulated model and the test data; and
incorporate the failure module parameter into the simulated model.

5. The system of claim 1, wherein:
the plurality of modules comprises a viscoelasticity module that utilizes a stress-relaxation curve to fit at least one of the plurality of interrelated material behaviors related to viscoelasticity;
the plurality of modules comprises a hyperelastic module and an unloading module that utilize a cyclic stress-strain curve to fit the hyperelastic module and the unloading module, while utilizing data from the viscoelasticity module;
the plurality of modules comprises a yield module that utilizes the cyclic stress-strain curve in an anisotropic direction;
the plurality of modules comprises a hardening module parameter, wherein the hardening module parameter comprises at least one of the following: isotropic hardening and kinematic hardening; and
the plurality of modules comprises a viscoplasticity module that utilizes the cyclic stress-strain curve.

6. The system of claim 5, wherein the unloading module includes a Mullins Effect.

7. The system of claim 5, wherein the viscoelasticity module utilizes a Prony series.

8. A method for material modeling, comprising:
determining test data for a test material, the test material exhibiting a plurality of interrelated material behaviors, the test data relating to the plurality of interrelated material behaviors;
utilizing a stress relaxation stress-strain curve to fit a first set of parameters of the test material into a viscoelasticity module;
utilizing a cyclic stress-strain curve to fit a second set of parameters of the test material to a hyperelastic module and unloading module;
utilizing the cyclic stress-strain curve to determine a yield module;
utilizing the cyclic stress-strain curve to fit a third set of parameters of the test material to a hardening module;
utilizing the cyclic stress-strain curve to fit a fourth set of parameters of the test material to a viscoplasticity module;
assembling a simulated model of the test material from the viscoelasticity module, the hyperelastic module, the unloading module, the yield module, the hardening module, and the viscoplasticity module;
simulating a physical test of the simulated model and compare a test result to a predetermined standard; and
providing the test result for display.

9. The method of claim 8, wherein the test data comprises a stress-strain curve for the test material, the stress-strain curve comprising at least one of the following: a tension-compression curve at a variety of strain rates, a cyclic tension-compression curve, and a stress-relaxation curve.

10. The method of claim 8, further comprising:
utilizing an output of the physical test to form an input for a failure module parameter of the simulated model, wherein the failure module parameter is determined, based on results from the simulated model and the test data; and
incorporating the failure module parameter into the simulated model.

11. The method of claim 8, wherein the unloading module includes a Mullins Effect.

12. The method of claim 8, wherein the viscoelasticity module utilizes a Prony series.

13. The method of claim 8, wherein the test result includes data for a plurality of environmental conditions for the test material.

14. The method of claim 8, further comprising:
determining that the test result does not meet the predetermined standard;
in response to determining that the test result does not meet the predetermined standard, altering at least one of the following: the viscoelasticity module, the hyperelastic module, the unloading module, the yield module, the hardening module, and the viscoplasticity module; and
resimulating the physical test.

15. A non-transitory computer-readable medium for material modeling that stores a program that, when executed by a computing device, causes the computing device to perform the following:
determine test data for a test material, the test material exhibiting a plurality of interrelated material behaviors, the test data relating to the plurality of interrelated material behaviors;
provide the test data to a user;
receive a process from the user for decoupling at least two of the plurality of interrelated material behaviors;
in response to receiving the process for decoupling at least two of the plurality of interrelated material behaviors, fit a plurality of modules to simulate the test material, each of the plurality of modules relating to at least one of the plurality of interrelated material behaviors;
assemble a simulated model of the test material from the plurality of modules;
simulate a physical test of the simulated model and compare a test result to a predetermined standard;
utilize an output of the physical test to form an input for a failure module parameter of the simulated model, wherein the failure module parameter are determined, based on results from the simulated model and the test data;
incorporate the failure module parameter into the simulated model; and
provide the test result for display.

16. The non-transitory computer-readable medium of claim 15, wherein the test data comprises a stress-strain curve for the test material, the stress-strain curve comprising at least one of the following: a tension-compression curve at a variety of strain rates, a cyclic tension-compression curve, and a stress-relaxation curve.

17. The non-transitory computer-readable medium of claim 15, wherein the plurality of modules comprises at least one of the following: a viscoelasticity module, a hyperelastic module, an unloading module, a yield module, a hardening module, and a viscoplasticity module.

18. The non-transitory computer-readable medium of claim 15, wherein:
the plurality of modules comprises a viscoelasticity module that utilizes a stress-relaxation curve to fit at least one of the plurality of interrelated material behaviors related to viscoelasticity;
the plurality of modules comprises a hyperelastic module and an unloading module that utilize a cyclic stress-strain curve to fit the hyperelastic module and the unloading module, while utilizing data from the viscoelasticity module;
the plurality of modules comprises a yield module that utilizes the cyclic stress-strain curve in an anisotropic direction;
the plurality of modules comprises a hardening module parameter, wherein the hardening module parameter comprises at least one of the following: isotropic hardening and kinematic hardening; and
the plurality of modules comprises a viscoplasticity module that utilizes the cyclic stress-strain curve.

19. The non-transitory computer-readable medium of claim 18, wherein the unloading module includes a Mullins Effect.

20. The non-transitory computer-readable medium of claim 18, wherein the viscoelasticity module utilizes a Prony series.
